(19) United States
(12) Patent Application Publication
(10) Pub. No.: US 2008/0114959 A1
(43) Pub. Date: May 15, 2008

(54) Image Formation System and Image Formation Device

(75) Inventor: Ryuichi Nitta, Kadoma-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: KYOCERA MITA CORPORATION, Osaka (JP)

(21) Appl. No.: 11/937,939

(22) Filed: Nov. 9, 2007

(30) Foreign Application Priority Data
Nov. 10, 2006 (JP) P2006305126

(51) Int. Cl. G06F 12/14

(52) U.S. Cl. 711/164; 711/E12.093

(57) ABSTRACT

An image formation system includes: an image formation device having a storage unit; a host device that outputs an image formation instruction including a predetermined code for authentication to the image formation device; a communication line that interconnects the host device with the image formation device, wherein the image formation device is adapted to store the image formation instruction in the storage unit when the image formation instruction including the code for authentication is input, and outputs an image based on the image formation instruction when an operating information matching the code for authentication is input from a user interface.

### CROSS-REFERENCE TO RELATED APPLICATION

The present application claims priority on the Japanese Patent Application No. 2006-305126 filed Nov. 10, 2006, the content of which is incorporated herein by reference.

### BACKGROUND OF THE INVENTION

1. Field of the Invention

The present invention relates to an image formation system including a host device and an image formation device, and the present invention also relates to an image formation device used in the image formation system.

2. Description of Related Art

Some image formation devices receive an image formation instruction output from a host device connected via a network and output an image according to the image formation instruction. An image formation instruction adds, if it is, for example, a printing instruction, printing requirements (for example, number of sheets and scale to be printed) with data indicating an image to be printed (hereinafter referred to as image data).

Furthermore, an image formation device is generally equipped with a storage unit that temporarily stores the image formation instruction and the image data.

Some of the recent image formation devices are equipped with storage units, as a type of the storage unit, which is capable of storing the image formation instruction and the image data according to the arbitral operation of the user. When the storage units allocate the regions allowed to be used per user or per division, each of these regions in the storage unit may be protected with password authentication.

Currently, a large number of host devices are connected to the image formation devices via networks in a large number of offices. It is not an exception that the image formation devices are away from the host devices the users are using. In some cases, users away from the image formation devices, output printed matters not favorable to be viewed by an unspecified majority such as confidential documents. In this specific case, the users store the image formation instructions and the image data into a storage unit that should be protected using the password authentication, and then they move to the position where the image formation device is installed and input the password so that the printing operation is executed. T his transaction prevents the printed matters from being received by the others.

Such an image formation device includes the one disclosed, for example, in Japanese Unexamined Patent Application, First Publication No. H10-304160. This image formation device allocates a memory (corresponding to the storage unit) region per user, and requests the user to input a password for authentication when the user outputs printed matters according to the image data stored in each region.

An image formation device described in the patent document includes a storage unit having each region protected by the password authentication. Each of the image data stored in the storage unit, however, is not protected for securing confidentiality. When the password set for each region of the storage unit were known to those other than authorized users allowed to use the regions, all image data stored in the regions would come under threat of being exposed.

When a region is allocated per user, as in the storage unit of the image formation device described above, in general, a password for each region is often administrated by an administrator. Administrators or malicious users who illegally obtain a password list, that were in the possession of an administrator, are likely the ones who leak passwords. Furthermore, authorized users are likely to leak passwords of the regions allocated to them through lack of discretion.

Accordingly, more rooms are left to improve in the method for securing confidentiality in which each user is allocated a region of the storage unit and a password is set for each region.

### SUMMARY OF THE INVENTION

Under the above-described circumstance, an object of the present invention is to allow only specific users, such as those who operate the host device to output an image formation instruction and those authorized by users to obtain image formation printed matters, to obtain the image formation printed matters according to the image formation instructions.

In order to solve the above problems, the present invention provides an image formation system including: an image formation device having a storage unit; a host device that outputs an image formation instruction including a predetermined code for authentication to the image formation device; a communication line that interconnects the host device with the image formation device, wherein the image formation device is adapted to store the image formation instruction in the storage unit when the image formation instruction including the code for authentication is input, and outputs an image based on the image formation instruction when an operating information matching the code for authentication is input from a user interface.

In the above image formation system, the host device may output the image formation instruction, which includes the code for authentication that has been input by a user, to the image formation device.

In the above image formation system, the host device may accept the code for authentication that has been arbitrarily set by a user.

In the above image formation system, the image formation device may show the user, via the user interface, a list of the image formation instructions stored in the storage unit, and accept a selection by the user of an image formation to be executed.

In the above image formation system, when the user interface accepts input of the code for authentication by the user, the image formation device may output an image according to all of the image formation instructions associated with the accepted code for authentication out of the image formation instructions stored in the storage unit.

In the above image formation system, the host device accepts input of a retention time by the user when the image formation instruction including the code for authentication is output, and the image formation device may delete the image formation instruction from the storage unit if the retention time passes from when the image formation instruction including the code for authentication is output.

The present invention also provides an image formation device including: a communication unit communicating with an external host device that outputs an image formation instruction including a code for authentication; a storage unit storing the image instruction received by the communication unit; a user interface receiving operating information from a user; an output unit outputting an image; and a control unit comparing the code for authentication with the operating information and making the output unit output an image according to the image formation instruction when the code for authentication matches the operating information.

According to the present invention, when a host device outputs an image formation instruction, including codes for authentication, the image formation instruction is stored in a storage unit of an image formation device. When the operating information matches the code for authentication, included in the image formation instruction is input from a user interface, an image formation device outputs an image according to the image formation instruction so that users who know the codes for authentication included in the image instruction can only output an image according to the image formation instruction. As a result, only specific users such as those who operated the host device to output an image formation instruction can obtain the image formation output matters according to the image formation instruction and those authorized by the users to obtain the image formation printed matters.

### BRIEF DESCRIPTION OF THE DRAWINGS

FIG. 1 is a block diagram illustrating a configuration of an image formation system according to an embodiment of the present invention.

FIG. 2 is a flowchart illustrating a flow of a printing process (image formation process) according to an embodiment of the present invention.

### DETAILED DESCRIPTION OF THE INVENTION

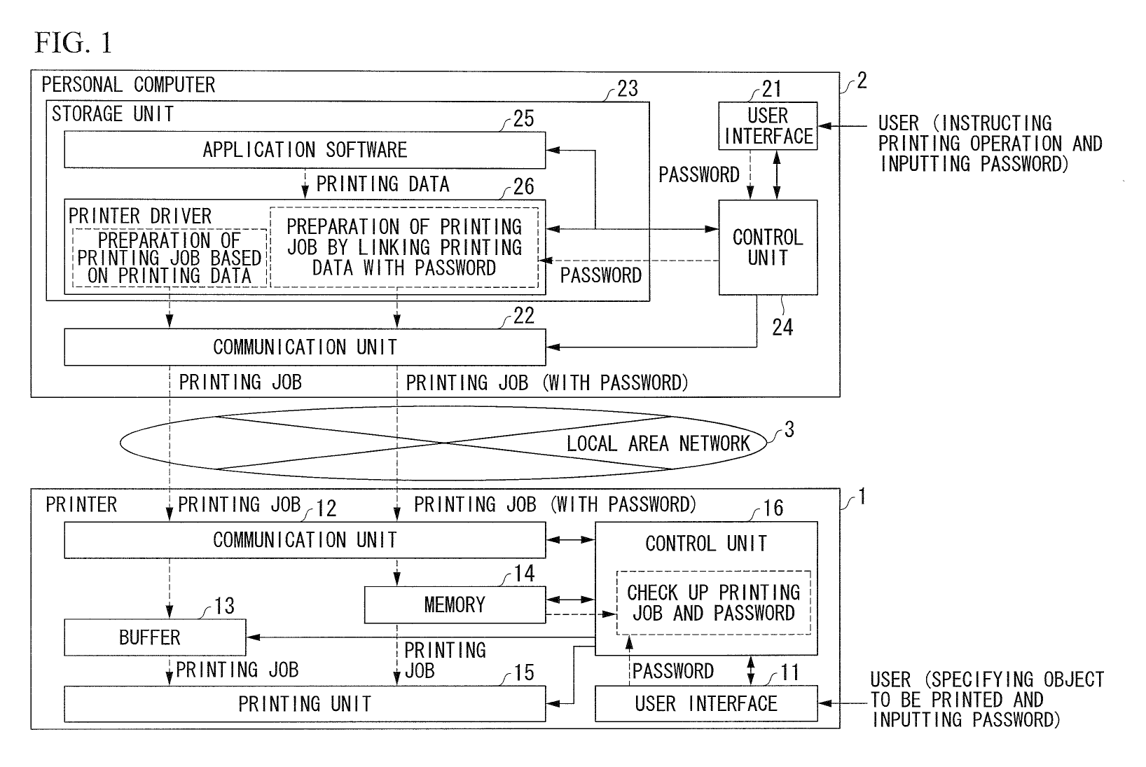

An embodiment of the present invention is described by making reference to the following description, taken in conjunction with the accompanying drawings. FIG. 1 is a block diagram illustrating a configuration of an image formation system according to an embodiment of the present invention. The image formation system includes a printer 1 (image formation device), a personal computer 2 (host device), and a local area network (communication line) 3 connecting the printer 1 with the personal computer 2.

It should be noted that FIG. 1 illustrates one personal computer 2; however, a plurality of personal computers not illustrated herein is actually connected to the printer 1 via the local area network 3.

The printer 1 is equipped with a user interface (I/F) 11, a communication unit 12, a buffer 13, a memory 14 (storage unit), a printing unit 15 (output unit) and a control unit 16.

The user interface 11 includes an operation key and a display panel. The operation key that receives an operating instruction for the printer 1 from a user, outputs a signal supporting an operating instruction from a user to the control unit 16. The display panel displays an image for a user to verify an operating condition of the printer 1 under the control of the control unit 16.

The communication unit 12 transmits and receives various information with an external device via the local area network 3, under the control of control unit 16.

The buffer 13 temporarily and sequentially stores a printing job (image formation instruction) accepting from the personal computer 2, and sequentially outputs the same to the printing unit 15. The printing job includes information instructing to print, i.e., data for printing that is obtained by adding a printing condition (for example, number of sheets and scale to be printed) to data indicating an image to be printed (hereinafter referred to as image data) to a printing condition (for example, number of sheets and scale to be printed), and the printing job is output from the personal computer 2 and input to the printer 1 via the local area network 3.

The memory 14 temporarily stores a printing job. The printing job stored in the memory 14 includes the data for printing, as well as a password (code for authentication). When the communication unit 12 receives a printing job with a password from the personal computer 2, the memory 14 sequentially stores the printing job with the password under the control of the control unit 16. Then, the memory 14 outputs the printing job to the printing unit 15 under the control of the control unit 16 when the user interface 11 receives the password for the printing job.

The printing unit 15 includes a well-known photosensitive drum, an electrostatic latent image-writing device, a development device, and a fixing device. The unit prints an image that should be printed, and outputs a printed matter according to a printing job.

The control unit 16 is adapted to an internal memory, a CPU (Central Processing Unit), and various input-output interface lines that transmit and receive data with other units (i.e., the user interface 11, the buffer 13, the memory 14 and the printing unit 15), and controls the entire operation of the printer 1.

The internal memory stores a control program. The CPU collectively controls the other units by means of conducting control operations based on signal inputs from the control program, the data for various controls, and the user interface 11.

The personal computer 2 includes a user interface 21, a communication unit 22, a storage unit 23, and a control unit 24.

The user interface 21 includes a keyboard device, a display device, and speakers, etc. The keyboard device receives an operating instruction to the personal computer 2 from a user, and outputs signals according to the operating instruction by the user to the control unit 24.

The display device displays an image that a user acknowledges as an operating condition of the personal computer 2 under the control of the control unit 24. The speakers generate sound for attention or any other purposes for the user.

The communication unit 22 transmits and receives various types of information with an external device via the local area network 3 under the control of the control unit 24.

The storage unit 23 stores various application software 25, drivers that control various hardware connected to the personal computer 2, such as a printer driver 26 that transmits an instruction from a user to the printer 1, and various setup values.

The control unit 24 is adapted to an internal memory, a CPU, (Central Processing Unit), and various input-output interface lines that transmit and receive data with other units (i.e., the user interface 21 and the storage unit 23), and controls the entire operation of the personal computer 2.

The internal memory stores a control program. The CPU collectively controls the other units by means of conducting control operations based on the aforementioned control program, various controls data, and signals input through the user interface 21.

The control unit 24 controls storage of the storage unit 23. The control unit 24 realizes functions of the application software 25 and the printer driver 26 by means of operating according to the application software 25 stored in the storage unit 23, the program of the printer driver 26, and operating instructions by the user.

The local area network 3 is installed, for example, by a wire or wireless line across the entire area in the same company, enabling delivery of information in the same company by means of transmitting and receiving electronic data. Thus, the printer 1 and the personal computer 2 are connected in a communicable interface.

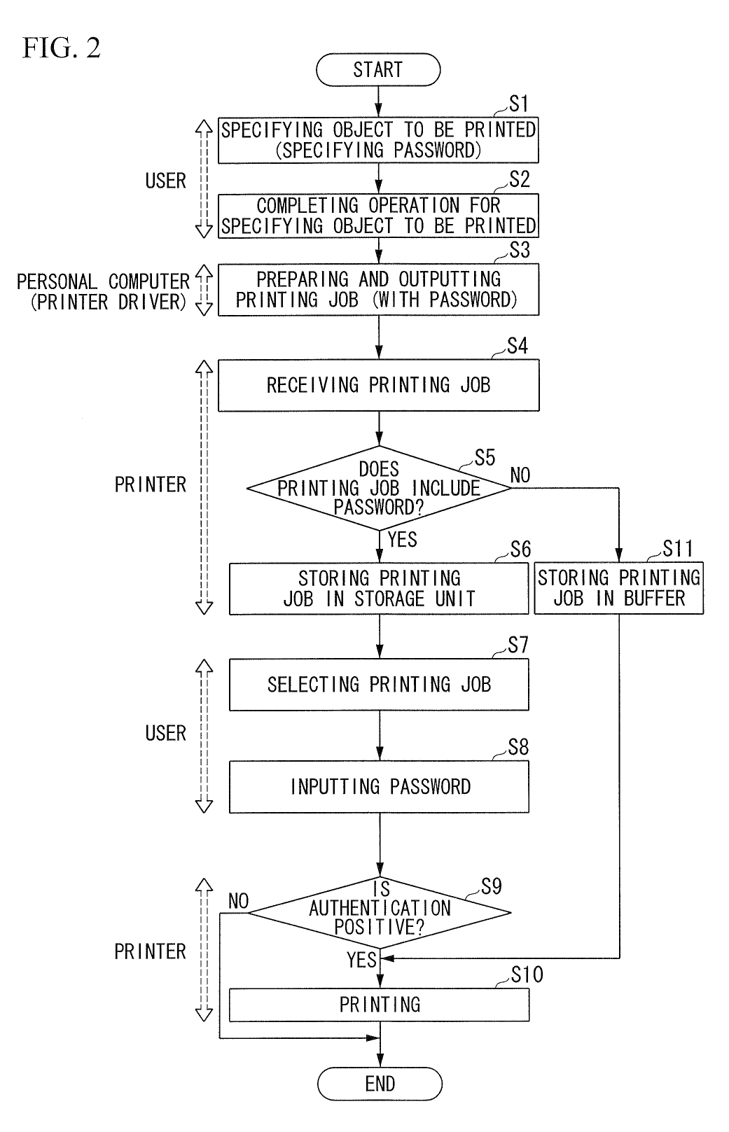

Next, a printing process in the present image formation system with the aforementioned structure is described by referring to FIG. 2. FIG. 2 is a flowchart illustrating a printing process (image formation process) according to the present embodiment of the present invention.

A user conducts the user interface 21 of the personal computer 2 and specifies an object to be printed by the printer driver 26 via the application software 25 under operation (step S1). The user accordingly specifies the object to be printed as well as a password if the object to be printed is a document requiring confidentiality. The password hereof can be set in random letter strings by the user.

The functions of the application software 25 and the printer driver 26 hereof are achieved by the control unit 24 that operates according to the program description of this application software 25 and the printer driver 26.

When the user operates an instruction indicating that specifying the object to be printed is completed (step S2), the control unit 24 in operation according to the printer driver 26 prepares a printing job including the aforementioned data for printing, and outputs the same to the communication unit 22, whereby the communication unit 22 outputs the same to the printer 1 via the local area network 3 under the control of the control unit 24 (step S3). If the user also specified the password together with the object to be printed in step S1, the control unit 24 in operation according to the printer driver 26 prepares a printing job including data for printing and the password and outputs the same to the printer 1.

Next, when the communication unit 12 of the printer 1 receives the printing job (step S4), the communication unit 12 outputs a result of receiving and a list of received information to the control unit 16. If the communication unit 12 receives the printing job that has included the password, the fact is recorded in the list of received information.

When the list of received information is output to the control unit 16 by the communication unit 12, the control unit 16 determines whether or not the printing job includes the password (step S5) by referring to the list of received information. If the printing job includes the password (when it is determined “Yes” in step S5), the control unit 16 stores the printing job thereof into the memory 14 (step S6).

Upon making the personal computer 2 output the printing job with the password, the user leaves his/her desk and moves to where the printer 1 is located in order to output the printed matter processed by the printing job with the password. Then, the user operates the operating keys of the interface 11 in the printer 1, so that the display panel of the user interface 11 lists the letter strings specifying the printing job stored in the memory 14.

The letter strings specifying the printing job hereof are, for example, the name of the personal computer 2 that outputs the printing job, the user name of the personal computer 2, or the name of the original document used as the data for printing, that is included in the print job, and the likes.

The user uses the operating keys of the user interface 11 to select a printing job for an object to be printed from the list displayed on the display panel of the user interface 11 (step S7), and further inputs the password supporting the printing job, in other words, the password specified together with the object to be printed (step S8).

The user interface 11 outputs the information showing the printing job selected by the user, and the password received its input from the user to the control unit 16. The control unit 16 reads out the printing job that matches the information indicating the printing job input from the user interface 11.

The control unit 16 checks the password input from the user interface 11 with the password added to the printing job read out from the memory 14 (step S9). If both of the passwords match, the control unit 16 confirms the authentication positive (when it is confirmed in step S9) and makes the printing unit 15 output the printed matter according to the printing job (step S10). When the authentication is negative (when it is not confirmed in step S9), processing is finished without printing. As described above, printing is processed only when the authentication is positive.

It should be noted that when it is determined in step S5 that the printing job does not include a password (when it is determined negative in step S5), the control unit 16 sequentially stores the printing job into the buffer 13 (step S11), and the buffer 13 sequentially outputs the same to the printing unit 15, whereby the printing unit 15 prints the printed matter according to the printing job (step S10).

According to the present embodiment, when a user specifies the object to be printed, as well as the password at the personal computer 2 so that a printing job is provided with the password, the printing job is stored into the memory 14 at the printer 1, and then the printed matter associated with the printing job can be output upon inputting of the password by the user at the printer 1.

Therefore, it is impossible for users who do not know the password to output the printed matter by the printing job. As a result, only the users who operated the personal computer 2 to output the printing job and specific users, including those whom the users have allowed to obtain printed matters and given the password, can obtain the printed matters processed by the printing job.

Furthermore, this effect can maintain high confidentiality since a user can optionally set the password every time when a printing job is set. More specifically, the password is determined when an object to be printed is specified, so that it requires a shorter amount of time to store the password in comparison with the case in which the preset and registered (such as default) password is input. Thus, it can be said that the risk of leaking a password is lower. Furthermore, it is easier for a user to memorize a password because the user may even input a password that comes to his/her mind at that moment instead of inputting a predetermined password.

Although the present embodiment shows a desirable printing job with the password stored in the memory 14, which is selected by the user interface 11 (step S7 in FIG. 2), in practice, the printed matters by all of the printing jobs with the password matching the password received its input in step S8 may be output instead of selecting in step S7.

According to the above, it is convenient because of the same password added to those printing jobs, so that printed matters processed by a plurality of printing jobs with the same password added can be obtained at the same time by entering the password one-time when the printed matters are output from the printer 1.

Moreover, in practice, a user may also specify a retention time when the user specifies the password together with the object to be printed, so that the limit of retention time for retaining the printing job in the memory 14 from the issuance thereof can be determined, and the printing job can be deleted from the memory 14 over the limit of the retention time.

According to the above, the printing job can be deleted from the memory 14 when the predetermined retention time passes even though the user cannot move to the printer 1 for outputting the printed matter after the issuance of the printing job with a password due to various reasons. Therefore, an event can be avoided so that documents requiring the confidentiality would remain stored for a long period of time in the memory 14 that is under unspecified majority use.

What is claimed is:

1. An image formation system comprising:
an image formation device having a storage unit;
a host device that outputs an image formation instruction including a predetermined code for authentication to the image formation device;
a communication line that interconnects the host device with the image formation device, wherein
the image formation device is adapted to store the image formation instruction in the storage unit when the image formation instruction including the code for authentication is input, and outputs an image based on the image formation instruction when an operating information matching the code for authentication is input from a user interface.

2. The image formation system according to claim 1, wherein the host device outputs the image formation instruction, which includes the code for authentication that has been input by a user, to the image formation device.

3. The image formation system according to claim 1, wherein the host device accepts the code for authentication that has been arbitrarily set by a user.

4. The image formation system according to claim 1, wherein the image formation device shows the user, via the user interface, a list of the image formation instructions stored in the storage unit, and accepts a selection by the user of an image formation to be executed.

5. The image formation system according to claim 1, wherein, when the user interface accepts input of the code for authentication by the user, the image formation device outputs an image according to all of the image formation instructions associated with the accepted code for authentication out of the image formation instructions stored in the storage unit.

6. The image formation system according to claim 1, wherein the host device accepts input of a retention time by the user when the image formation instruction including the code for authentication is output, and the image formation device deletes the image formation instruction from the storage unit if the retention time passes from when the image formation instruction including the code for authentication is output.

7. An image formation device comprising:
a communication unit communicating with an external host device that outputs an image formation instruction including a code for authentication;
a storage unit storing the image instruction received by the communication unit;
a user interface receiving operating information from a user;
an output unit outputting an image; and
a control unit comparing the code for authentication with the operating information and making the output unit output an image according to the image formation instruction when the code for authentication matches the operating information.
